(19) United States
(12) Patent Application Publication
(10) Pub. No.: US 2019/0055636 A1
(43) Pub. Date: Feb. 21, 2019

(54) METHOD FOR MAKING ALLOY MATRIX COMPOSITE

(71) Applicants: Tsinghua University, Beijing (CN); HON HAI PRECISION INDUSTRY CO., LTD., New Taipei (TW)

(72) Inventors: LUN-QIAO XIONG, Beijing (CN); WEN-ZHEN LI, Beijing (CN); LIN ZHU, Beijing (CN)

(21) Appl. No.: 15/869,567

(22) Filed: Jan. 12, 2018

(30) Foreign Application Priority Data
Aug. 17, 2017 (CN) 201710708973.4

(51) Int. Cl. C22C 47/20; C22C 49/14; B82Y 30/00

(52) U.S. Cl. CPC C22C 47/20; C22C 2047/005; B82Y 30/00; C22C 49/14

(57) ABSTRACT

A method for making alloy matrix composite, comprising: providing a metal matrix composite, the metal matrix composite includes a metal body and a reinforcement body; placing an alloying element layer on a surface of the metal matrix composite to obtain a first composite structure; rolling the first composite structure to obtain a middle composite structure; repeatedly folding and rolling the middle composite structure to obtain a second composite structure; annealing the second composite structure to obtain the alloy matrix composite.

### CROSS-REFERENCE TO RELATED APPLICATIONS

This application claims all benefits accruing under 35 U.S.C. § 119 from China Patent Application No. 201710708973.4, filed on Aug. 17, 2017 in the China Intellectual Property Office, disclosure of which is incorporated herein by reference.

### BACKGROUND

### 1. Technical Field

The present disclosure relates to a method for making alloy matrix composite.

### 2. Description of Related Art

With the development of mechanical engineering, electronics, electrical and electronic, aerospace and other fields, alloy materials receives extensive attention in fields of research and application. Because of their mechanical, electrical, and chemical properties, alloy is a kind of important structural and functional material.

Currently, alloy matrix composites are mainly made by a powder metallurgy method. The powder metallurgy method includes: adding a reinforcement powder to an alloy matrix powder to form a mixed powder, then pressing and sintering the mixed powder to form the alloy matrix composite. A type of the reinforcement powder and an amount of the reinforcement powder can be selected according to actual needs. The alloy matrix composites have brought more opportunities and possibilities for the alloys' research and development, and further enriches and improves the performance and application of the alloys.

However, high-temperature sintering readily generates additional products at an interface between the reinforcement and the alloy matrix in the powder metallurgy method, which causes property deterioration of the alloy matrix composite and limits the available types of the reinforcements. Further, the alloy matrix composite formed by the powder metallurgy method has a plurality of pores, which reduces the strength and toughness of the alloy matrix composites

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a flow chart showing one exemplary embodiment of a method for making the alloy matrix composite.

FIG. 2 is a schematic drawing showing one exemplary embodiment of a method for making the alloy matrix composite.

FIG. 3 is a flow chart showing one exemplary embodiment of a method for making carbon nanotube reinforced copper-nickel (Cu—Ni) alloy composite.

FIG. 4A is an X-ray diffraction pattern showing one exemplary embodiment of a second composite structure before annealing and the second composite structure after annealing for making the alloy matrix composite.

FIG. 4B is a SEM image showing one exemplary embodiment of a cross section of a carbon nanotube reinforced copper-nickel (Cu—Ni) alloy composite.

FIG. 5 is a flow chart showing one exemplary embodiment of a method for making carbon nanotube reinforced copper-zinc (Cu—Zn) alloy composite.

FIG. 6A is an X-ray diffraction pattern showing another exemplary embodiment of the second composite structure before annealing and the second composite structure after annealing for making the alloy matrix composite.

FIG. 6B is a SEM image showing another exemplary embodiment of a cross section of a carbon nanotube reinforced copper-zinc (Cu—Zn) alloy composite.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series, and the like. It should be noted that references to “one” embodiment in this disclosure are not necessarily to the same embodiment, and such references mean at least one.

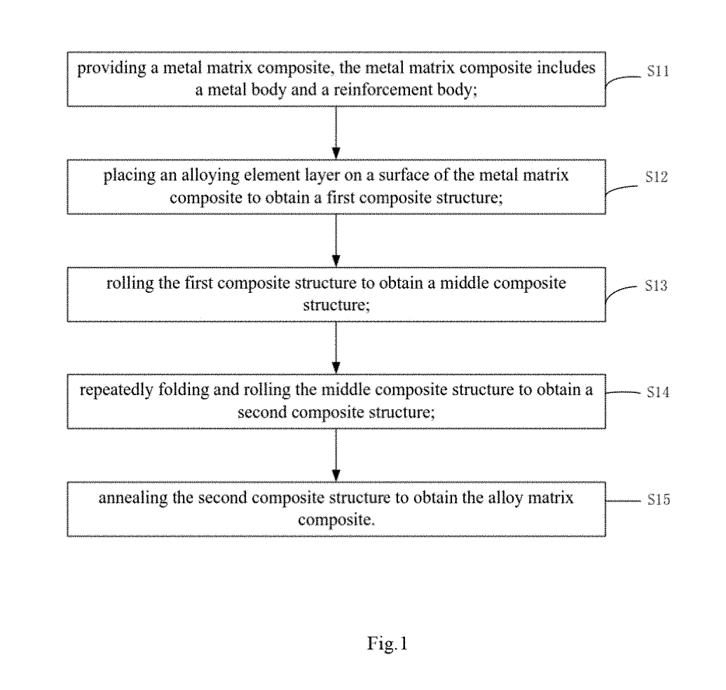

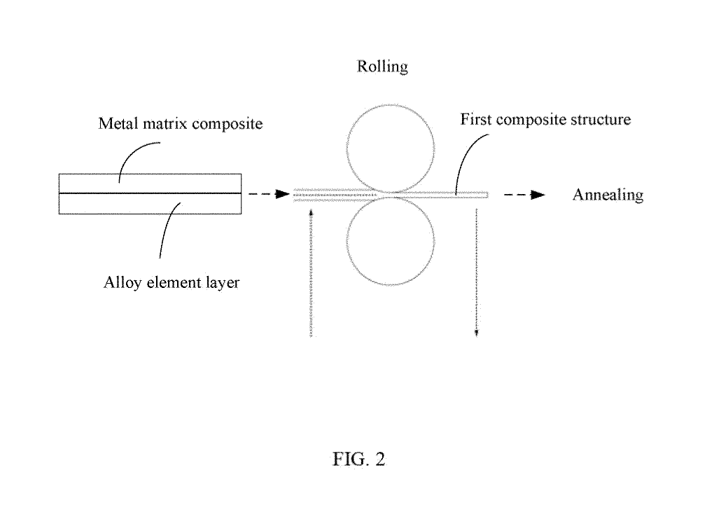

A method for making an alloy matrix composite according to one exemplary embodiment is provided. Referring to FIGS. 1-2, the method for making the alloy matrix composite includes the following steps:

S11, providing a metal matrix composite, the metal matrix composite includes at least one metal body and at least one reinforcement body;

S12, placing an alloying element layer on a surface of the metal matrix composite to obtain a first composite structure;

S13, rolling the first composite structure to obtain a middle composite structure; S14, repeatedly folding and rolling the middle composite structure to obtain a second composite structure;

S15, annealing the second composite structure to obtain the alloy matrix composite.

In step S11, a structure of the metal matrix composite is not limited. In one exemplary embodiment, the reinforcement body can be stacked on the metal body. In another exemplary embodiment, the reinforcement body can be in the metal body. A thickness of the metal matrix composite can be selected according to actual needs. In one exemplary embodiment, the thickness of the metal matrix composite is about 0.03 mm to about 3 mm.

The metal body can be made of at least one soft metal. The soft metal is a metal that has preferred plasticity and preferred ductility. The soft metal can be copper (Cu), aluminum (Al), silver (Ag) or gold (Au). In one exemplary embodiment, the metal body is made of copper.

The reinforcement body can be carbon nanotube structure, graphene, particles of Al₂O₃ or Si₃N₄. The carbon nanotube structure is not limited. The carbon nanotube structure can include at least one carbon nanotube. The carbon nanotube structure include a plurality of carbon nanotubes. The plurality of carbon nanotubes can be arranged in a disorder manner or formed a film structure. The film structure can be a drawn carbon nanotube film, a pressed carbon nanotube film or a flocculated carbon nanotube film.

A plurality of carbon nanotubes in the drawn carbon nanotube film are connected end to end by van der Waals attractive force and extend in the same direction. A plurality of carbon nanotubes in the pressed carbon nanotube are arranged in a same direction or in different direction. A plurality of carbon nanotubes in the flocculent carbon nanotube film are attracted to each other through van der Waals attractive force and wound to form a network structure.

In step S12, a method for placing an alloying element layer on the surface of the metal matrix composite to obtain a first composite structure is not limited. The method can include: stacking the alloying element layer on the surface of the metal matrix composite; or plating the alloying element layer on the surface of the metal matrix composite by electroplating or electroless plating; or folding the metal matrix composite and the alloying element layer is sandwiched between the metal matrix composites.

Material of the alloying element layer can be selected according to the alloy matrix composite to be formed. When the material of the metal body is copper, the alloying element layer can be a material selected from zinc (Zn), nickel (Ni), aluminum (Al), tin (Sn), and a combination thereof. In one exemplary embodiment, a thickness of the alloying element layer is about 0.03 mm to about 3 mm. A composition of the alloy in the alloy matrix composite can be controlled by simultaneously controlling the thickness of the metal matrix composite and the thickness of the alloying element layer.

In step S13, the method further includes: tailoring the first composite structure to overlap an edge of the metal matrix composite with edge of the alloying element layers. The method of rolling the first composite structure is not limited, and it is only necessary to ensure that the thickness of the first composite structure is reduced. In one exemplary embodiment, the thickness of the first composite structure is reduced to less than 70% of an initial thickness, wherein the initial thickness is the thickness of the first composite structure without being rolled. In one exemplary embodiment, the first composite structure is placed in an acetone solution and degreased by ultrasonification, and the first composite structure is rolled to reduce the thickness of the first composite structure to substantially half of the initial thickness to form the middle composite structure. Then, cracks on edge of the middle composite structure are removed.

Before step S14, the method can further include a step of treating the middle composite structure to roughen a surface of the middle composite structure, which can provide a better surface to combine with other surfaces. In one exemplary embodiment, the step of treating the middle composite structure includes: scrubbing the middle composite structure by a wire brush to obtain a treatment surface.

In step S14, the “folding and rolling” refers to a set of process. The process of folding and rolling includes: folding the middle composite structure, and then rolling the middle composite structure. Methods of the folding the middle composite structure are not limited. The middle composite structure is folded in half with the treatment surface inside, and then the middle composite structure is rolled after folding to reduce the thickness of the middle composite structure to less than 70%. In one exemplary embodiment, the thickness of the middle composite structure after rolling is reduced to 50%. The “repeatedly folding and rolling” means that the “folding and rolling” set of process is performed at least two times. The number times undergone “folding and rolling” is determined by the type and thickness of alloying elements in the alloying element layer.

In step S15, in the process of the repeatedly folding and rolling, the alloy element layer is located in the metal matrix composite in a multi-layer form, which makes the alloying element layer evenly arranged inside the metal matrix composite. With each rolling, the thickness of the alloying element layer decreases and becomes more bonded with the surface of the metal matrix composite, which shortens annealing time for the second composite structure.

The second composite structure defines a plurality of sandwich structures. The plurality of sandwich structures is stacked one by one. Each of the plurality of sandwich structure includes two layers of the metal matrix composite and the alloy element layer sandwiched between the two layers of the metal matrix composites.

In step S16, in the process of annealing the second composite structure, atoms in the alloy element layer and atoms in the metal body diffuse with each other and dissolve within each other to form an alloy matrix. The alloy matrix is evenly distributed in the alloy matrix composite. A shape of the reinforcement in the metal matrix composite does not change in the annealing process and the reinforcement is embedded in the alloy matrix.

The annealing temperature and time are determined by the type and composition of the alloy matrix in the alloy matrix composite. The annealing temperature in the present embodiment is in range from about 100° C. to about 600° C. The annealing time is in range from about 1 h to about 24 h. In one exemplary embodiment, the second composite structure is placed in a vacuum tube furnace charged with argon for annealing.

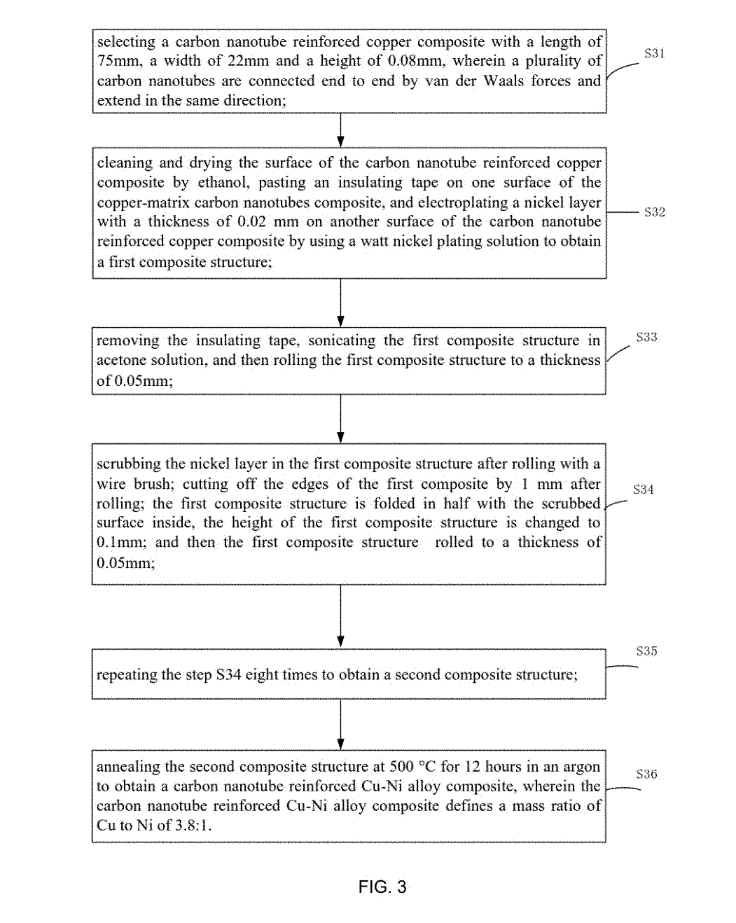

Referring to FIG. 3, one exemplary embodiment of a method for making carbon nanotube reinforced copper-nickel (Cu—Ni) alloy composite includes the following steps:

S31, selecting a carbon nanotube reinforced copper composite with a length of 75 mm, a width of 22 mm and a height of 0.08 mm, wherein a plurality of carbon nanotubes are connected end to end by van der Waals forces and extend in the same direction;

S32, cleaning and drying the surface of the copper-matrix carbon nanotubes composite by ethanol, pasting an insulating tape on one surface of the carbon nanotube reinforced copper-matrix composite, and electroplating a nickel layer with a thickness of 0.02 mm on another surface of the copper-matrix carbon nanotubes composite by using a watt nickel plating solution to obtain a first composite structure;

S33, removing the insulating tape, sonicating the first composite structure in acetone solution, and then rolling the first composite structure to a thickness of 0.05 mm;

S34, scrubbing the nickel layer in the first composite structure after rolling with a wire brush; cutting off the edges of the first composite by 1 mm after rolling; the first composite structure is folded in half with the scrubbed surface inside, the height of the first composite structure is changed to 0.1 mm; and then the first composite structure is rolled to a thickness of 0.05 mm;

S35, repeating the step S34 eight times to obtain a second composite structure;

S36, annealing the second composite structure at 500° C. for 12 hours in an argon atmosphere to obtain a carbon nanotube reinforced Cu—Ni alloy composite, wherein the carbon nanotube reinforced Cu—Ni alloy composite defines a mass ratio of Cu to Ni of 3.8:1.

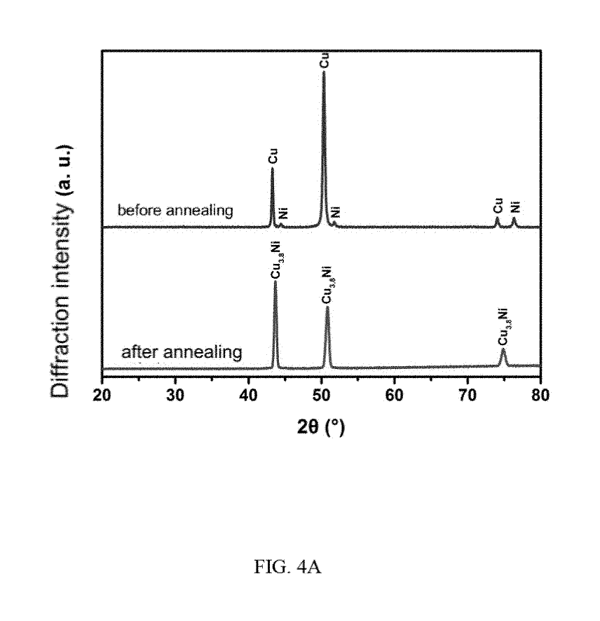

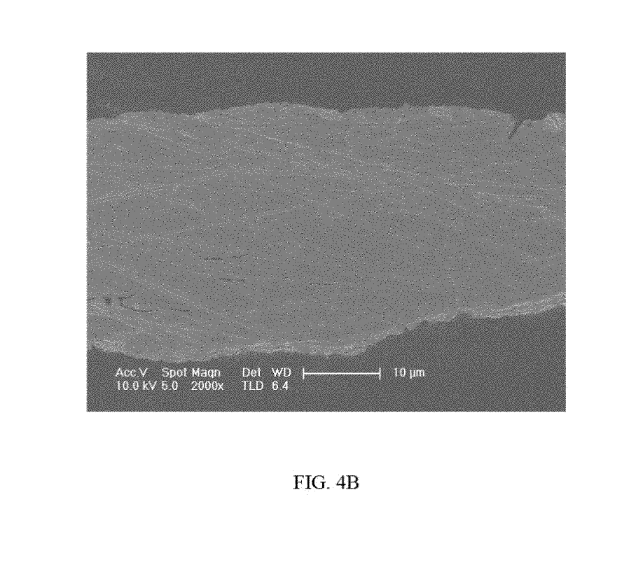

Because the surface of the second composite is pure copper, the color of the second composite structure before annealing is red. After annealing, because the copper atoms and the nickel atoms form a copper-nickel alloy, the color of the surface of the second composite structure turns from red to white. FIG. 4A shows that the copper atoms and nickel atoms form a copper-nickel alloy. FIG. 4B shows that pores do not exist in the copper-nickel alloy matrix composite and has preferred compactness.

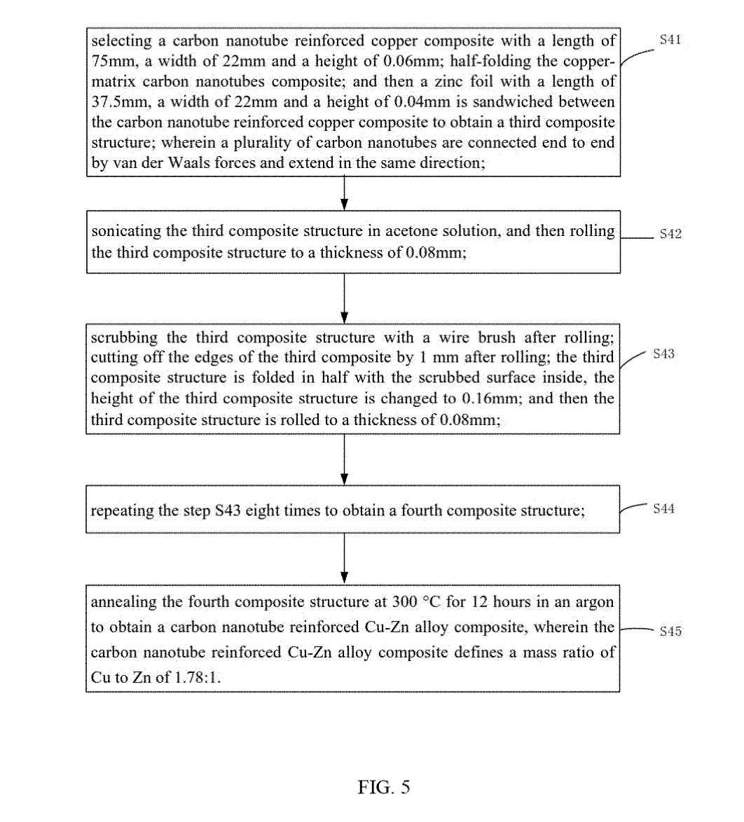

Referring to FIG. 5, another exemplary embodiment of a method for making carbon nanotube reinforced copper-zinc (Cu—Zn) alloy composite includes the following steps:

S41, selecting a carbon nanotube reinforced copper composite with a length of 75 mm, a width of 22 mm and a height of 0.06 mm; half-folding the copper-matrix carbon nanotubes composite; and then a zinc foil with a length of 37.5 mm, a width of 22 mm and a height of 0.04 mm is sandwiched between the carbon nanotube reinforced copper-matrix composite to obtain a third composite structure; wherein a plurality of carbon nanotubes are connected end to end by van der Waals forces and extend in the same direction;

S42, sonicating the third composite structure in acetone solution, and then rolling the third composite structure to a thickness of 0.08 mm;

S43, scrubbing the third composite structure with a wire brush after rolling; cutting off the edges of the third composite by 1 mm after rolling; the third composite structure is folded in half with the scrubbed surface inside, the height of the third composite structure is changed to 0.16 mm; and then the third composite structure is rolled to a thickness of 0.08 mm;

S44, repeating the step S43 eight times to obtain a fourth composite structure; S45, annealing the fourth composite structure at 300° C. for 12 hours in an argon atmosphere to obtain a carbon nanotube reinforced Cu—Zn alloy composite, wherein the carbon nanotube reinforced Cu—Zn alloy composite defines a mass ratio of Cu to Zn of 1.78:1.

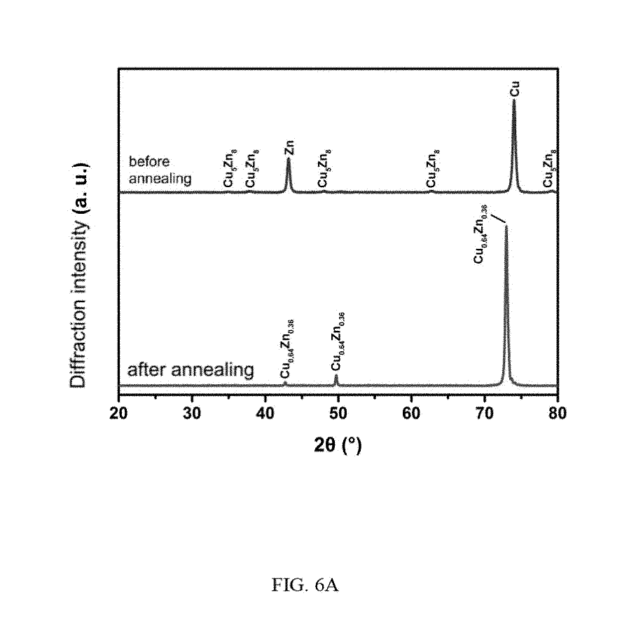

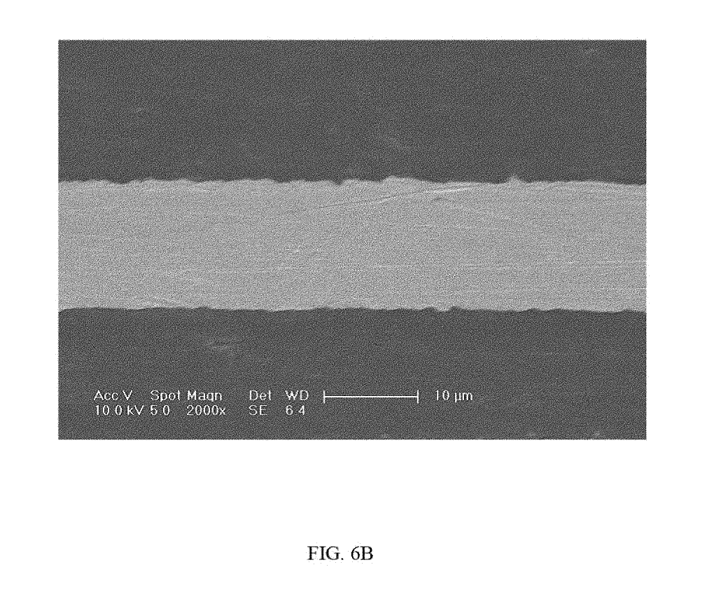

Because the surface of the fourth composite is pure copper, the color of the fourth composite structure before annealing is red. After annealing, because the copper atoms and the zinc atoms form a copper-zinc alloy, the color of the surface of the fourth composite structure turns from red to yellow. FIG. 6A shows that the copper atoms and zinc atoms form a copper-zinc alloy. FIG. 6B shows that pores does not exist in the copper-zinc alloy matrix composite and has preferred compactness.

There are many advantages to make the alloy matrix composite by the method of cumulative roll-bonding and annealing. First, content of the alloy matrix in the alloy matrix composite can be controlled by the initial thickness of the metal matrix composite and the alloying element layer. Second, the annealing temperature is much lower, which avoids generating additional products at an interface between the reinforcement and the alloy matrix, and broadens available types of the reinforcement. Third, the alloy matrix composite has less holes, high density, preferred ductility and toughness. Fourth, a large number of bulk materials are prepared at the same time, which is also easy to achieve pipeline operations.

It is to be understood that the above-described embodiments are intended to illustrate rather than limit the disclosure. Any elements described in accordance with any embodiments is understood that they can be used in addition or substituted in other embodiments. Embodiments can also be used together. Variations may be made to the embodiments without departing from the spirit of the disclosure. The above-described embodiments illustrate the scope of the disclosure but do not restrict the scope of the disclosure.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A method for making alloy matrix composite, comprising:
providing a metal matrix composite, wherein the metal matrix composite comprises at least one metal body and at least one reinforcement body;
placing an alloying element layer on a surface of the metal matrix composite to obtain a first composite structure;
rolling the first composite structure to obtain a middle composite structure;
repeatedly folding and rolling the middle composite structure to obtain a second composite structure;
annealing the second composite structure to obtain the alloy matrix composite.

2. The method of claim 1, wherein the metal body is made of copper, aluminum, silver, or gold.

3. The method of claim 1, wherein the reinforcement body is made of carbon nanotube structure, graphene, particles of Al₂O₃ or Si₃N₄.

4. The method of claim 3, wherein the carbon nanotube structure comprises a plurality of carbon nanotubes, wherein the plurality of carbon nanotubes is arranged in a disorder manner.

5. The method of claim 3, wherein the carbon nanotube structure has a film structure.

6. The method of claim 5, wherein the film structure comprises a drawn carbon nanotube film, a pressed carbon nanotube film, and a flocculated carbon nanotube film.

7. The method of claim 1, wherein placing an alloying element layer on a surface of the metal matrix composite, comprises: stacking the alloying element layer on the surface of the metal matrix composite.

8. The method of claim 1, wherein placing an alloying element layer on a surface of the metal matrix composite, comprises: plating the alloying element layer on the surface of the metal matrix composite by electroplating or electroless plating.

9. The method of claim 1, wherein placing an alloying element layer on a surface of the metal matrix composite, comprises: folding the metal matrix composite and providing the alloying element layer between the folded metal matrix composite.

10. The method of claim 1, before repeatedly folding and rolling the middle composite structure, roughening a surface of the middle composite structure.

11. The method of claim 1, wherein the second composite structure comprises a plurality of sandwiched structures, the plurality of sandwiched structures is stacked one by one.

12. The method of claim 11, wherein each of the plurality of sandwich structures comprises two layers of the metal matrix composite, and the alloy element layer are sandwiched between the two layers of the metal matrix composites.

13. The method of claim 1, wherein the annealing temperature is in range from about 100° C. to about 600° C.

14. The method of claim 1, wherein the annealing time is in range from about 1 hour to about 24 hours.
